(19) United States
(12) Patent Application Publication
(10) Pub. No.: US 2015/0304516 A1
(43) Pub. Date: Oct. 22, 2015

(54) IMAGE FORMING APPARATUS AND CONTROL METHOD THEREFOR

(71) Applicant: CANON KABUSHIKI KAISHA, Tokyo (JP)

(72) Inventor: Xiaoli Wang, Tokyo (JP)

(21) Appl. No.: 14/682,150

(22) Filed: Apr. 9, 2015

(30) Foreign Application Priority Data
Apr. 18, 2014 (JP) 2014-086799

(51) Int. Cl. H04N 1/00; H04N 1/32

(52) U.S. Cl. CPC H04N 1/00891; H04N 1/32122; H04N 1/00954; H04N 1/00928; H04N 2201/0094

(57) ABSTRACT

Condition information indicating a condition for allowing a power source of an image forming apparatus to be set in an ON state is stored. In response to input of an instruction to turn on the power source of the image forming apparatus, a control unit configured to refer to the condition information is activated. The activated control unit refers to the condition information, and if it is determined that the condition indicated by the condition information is not satisfied, performs shutdown processing of the image forming apparatus.

### BACKGROUND OF THE INVENTION

1. Field of the Invention

The present invention relates to a power source management technique for an image forming apparatus.

2. Description of the Related Art

The power source of an image forming apparatus may be turned off due to a failure, company regulations, periodic maintenance, or the like, and prohibited from being turned on during a given time period or under a given condition. During this time period, it is desirable to maintain the power source in an OFF state. As one technique for this requirement, there is provided a technique in which if an image forming apparatus having a second power state with small power consumption does not satisfy an activation condition, it is prevented from returning from the second power state to the first power state (Japanese Patent Laid-Open No. 2012-203464).

In the method described in Japanese Patent Laid-Open No. 2012-203464, power is wastefully consumed by having the second power state. When the administrator causes the image forming apparatus to transit to the second power state using this method, he/she cannot modify the activation condition.

### SUMMARY OF THE INVENTION

The present invention has been made in consideration of the above problems, and provides a technique for maintaining an image forming apparatus with lower power consumption under a specific condition.

According to the first aspect of the present invention, there is provided an image forming apparatus comprising: a storage unit configured to store condition information indicating a condition for allowing a power source of the image forming apparatus to be set in an ON state; and an activation unit configured to, in response to input of an instruction to turn on the power source of the image forming apparatus, activate a control unit configured to refer to the condition information stored in the storage unit, wherein the control unit activated by the activation unit refers to the condition information stored in the storage unit, and if it is determined that the condition indicated by the condition information is not satisfied, performs shutdown processing of the image forming apparatus.

According to the second aspect of the present invention, there is provided a control method for an image forming apparatus including a storage unit configured to store condition information indicating a condition for allowing a power source of the image forming apparatus to be set in an ON state, the method comprising: an activation step of, in response to input of an instruction to turn on the power source of the image forming apparatus, activating a control unit configured to refer to the condition information stored in the storage unit, wherein the control unit activated in the activation step refers to the condition information stored in the storage unit, and if it is determined that the condition indicated by the condition information is not satisfied, performs shutdown processing of the image forming apparatus.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an image forming apparatus;

FIG. 2 is a block diagram showing examples of the arrangements of a controller 3 and NFC device 10;

FIGS. 3A and 3B are views for explaining the ON and OFF states of a power source;

FIGS. 4A and 4B are views for explaining the operation rules of the NFC device 10;

FIGS. 5A and 5B are a view and a flowchart, respectively, showing processing performed by the controller 3 and an NFC chip 102;

FIGS. 6A and 6B are a view and a flowchart, respectively, showing processing performed by the controller 3 and the NFC chip 102;

FIGS. 7A and 7B are a view and a flowchart, respectively, showing processing performed by the NFC chip 102; and

FIG. 8 is a view showing an example of the format of condition information.

### DESCRIPTION OF THE EMBODIMENTS

Embodiments of the present invention will be described below with reference to the accompanying drawings. Note that the embodiments to be described below are merely examples when the present invention is practiced concretely, and are practical embodiments of arrangements described in the appended claims.

### First Embodiment

As described above, there are needs to limit an operation of turning on the power source of an image forming apparatus. For example, there are needs to prohibit the use of the image forming apparatus from 10 p.m. to 8 a.m. for power saving, and needs to prohibit the use of the image forming apparatus which cannot be used due to a failure and is in a repair waiting state. To meet these needs, even if the user turns on the power source of the image forming apparatus, it is necessary to turn off the power source by immediately performing shutdown processing instead of maintaining the power-on state.

In this embodiment, condition information indicating a condition for maintaining the power source of the image forming apparatus in the ON state (or a condition for preventing the power source from being maintained in the ON state) is registered in the nonvolatile memory of the image forming apparatus. Even if the user turns on the image forming apparatus, when the condition indicated by the condition information is not satisfied (the condition for maintaining the power source in the ON state is not satisfied), shutdown processing is immediately performed not to maintain the power source in the ON state.

To meet the needs to “prohibit the use of the image forming apparatus from 10 p.m. to 8 a.m. for power saving”, for example, the condition information is information indicating a condition “a time period except for the time period from 10 p.m. to 8 a.m.”. To meet the needs to “prohibit the use of the image forming apparatus which cannot be used due to a failure and is in a repair waiting state”, the condition information is information indicating a condition “completion of repair”.

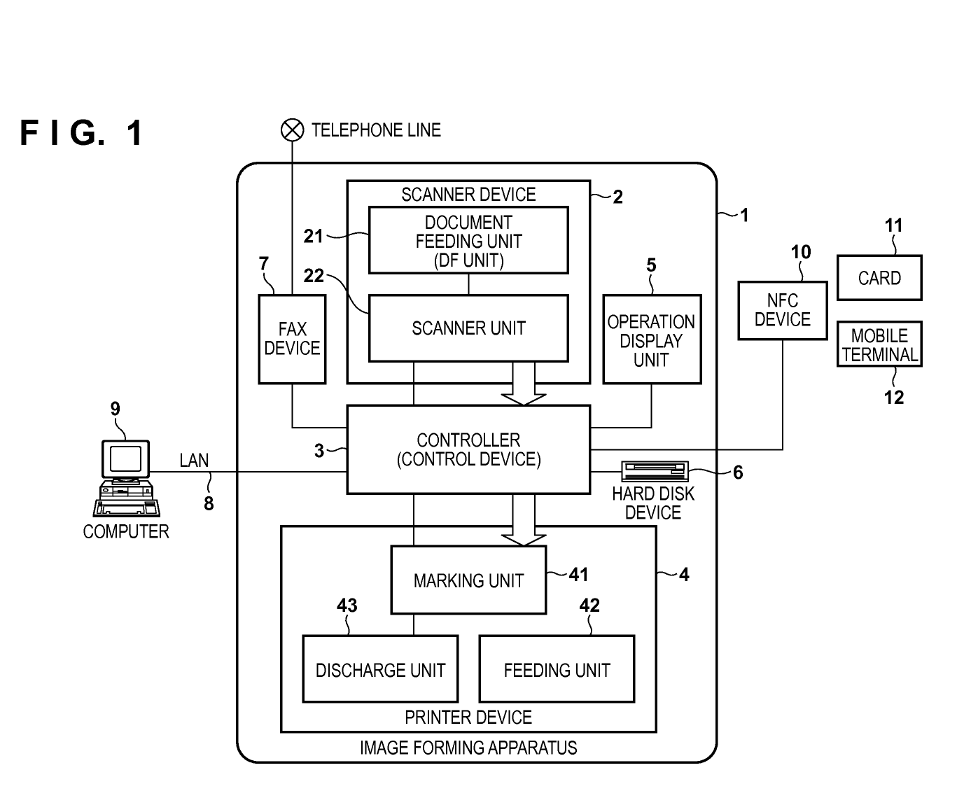

An example of the arrangement of an image forming apparatus according to this embodiment will be described with reference to a block diagram shown in FIG. 1. Note that the arrangement shown in FIG. 1 is merely an example. The arrangement of the image forming apparatus is not limited to that shown in FIG. 1, and various arrangements can be adopted.

As shown in FIG. 1, an image forming apparatus 1 is a multi function peripheral including a controller (control device) 3, a FAX device 7, a scanner device 2, an operation display unit 5, a hard disk device 6, and a printer device 4. An NFC (Near Field Communication) device 10 is connected to the image forming apparatus 1. Furthermore, a computer 9 such as a general PC (Personal Computer) is connected to the image forming apparatus 1 via a LAN 8. The image forming apparatus 1 will be described first.

The FAX device 7 is a device which performs FAX communication with an external device via a telephone line.

The scanner device 2 is a device which reads, as an image, information printed on a printing medium such as a paper sheet. The scanner device 2 includes a document feeding unit (DF unit) 21 and a scanner unit 22. Documents to be read by the scanner device 2 are set on the document feeding unit 21. The scanner unit 22 sequentially reads the documents set on the document feeding unit 21, and outputs the reading result as an image.

The operation display unit 5 is formed from hard keys, a touch panel screen, and the like, and provides an operation function to be operated by the user to input various instructions to the apparatus, and a display function of displaying various kinds of information.

The printer device 4 is a device which prints images and characters on a printing medium such as a paper sheet based on supplied print data. The printer device 4 includes a feeding unit 42 capable of feeding a bundle of sheets one by one, a marking unit 41 for printing images and characters on a sheet fed by the feeding unit 42, and a discharge unit 43 for discharging a printing medium printed by the marking unit 41.

The controller 3 controls the overall operation of the image forming apparatus 1, and also performs or controls each processing to be described later as processing performed by the image forming apparatus 1. For example, the controller 3 receives an image read by the scanner unit 22, and stores it in the hard disk device 6. Also, the controller 3 sends, to the printer device 4, print data transmitted by the computer 9 or print data generated from data instructed as a printing target by the operation display unit 5 among data registered in the hard disk device 6, and instructs to perform printing. The controller 3 performs various communications with the NFC device 10 and computer 9.

The hard disk device 6 stores an OS (Operating System), setting data of the image forming apparatus 1, and computer programs and data for causing the controller 3 to perform some or all of processes to be described as processes performed by the image forming apparatus 1. The computer programs include a computer program (power source management program) for turning on/off the power source of the image forming apparatus 1.

The image forming apparatus 1 with the above arrangement has a general copy function (a function of storing an image read by the scanner unit 22 in the hard disk device 6, and also sending the image to the printer device 4). The image forming apparatus 1 also has an image transmission function (a function of transmitting an image read by the scanner unit 22 to the computer 9 via the LAN 8) and an image saving function (a function of storing an image read by the scanner unit 22 in the hard disk device 6). Furthermore, the image forming apparatus 1 has an image print function (a function of causing the printer device 4 to perform printing based on print data (for example, PDL data) received from the computer 9 via the LAN 8). Note that functions which can be generally implemented by a copying machine are not limited to the above ones, and various functions can be implemented. The following description is not limited to the arrangement including the above functions.

The computer 9 will be explained. As described above, the computer 9 is a device such as a general PC, and can transmit print data, an instruction to turn off the power source, and the like to the image forming apparatus 1.

The NFC device 10 will be described. The NFC device 10 is a device (communication unit) for performing near field communication with an external device. In FIG. 1, it is possible to perform near field communication with a card 11 or a mobile terminal 12. Consequently, the NFC device 10 can transmit/receive data to/from the external device (the card 11 or mobile terminal 12 in FIG. 1), and allows the external device to edit data held in itself.

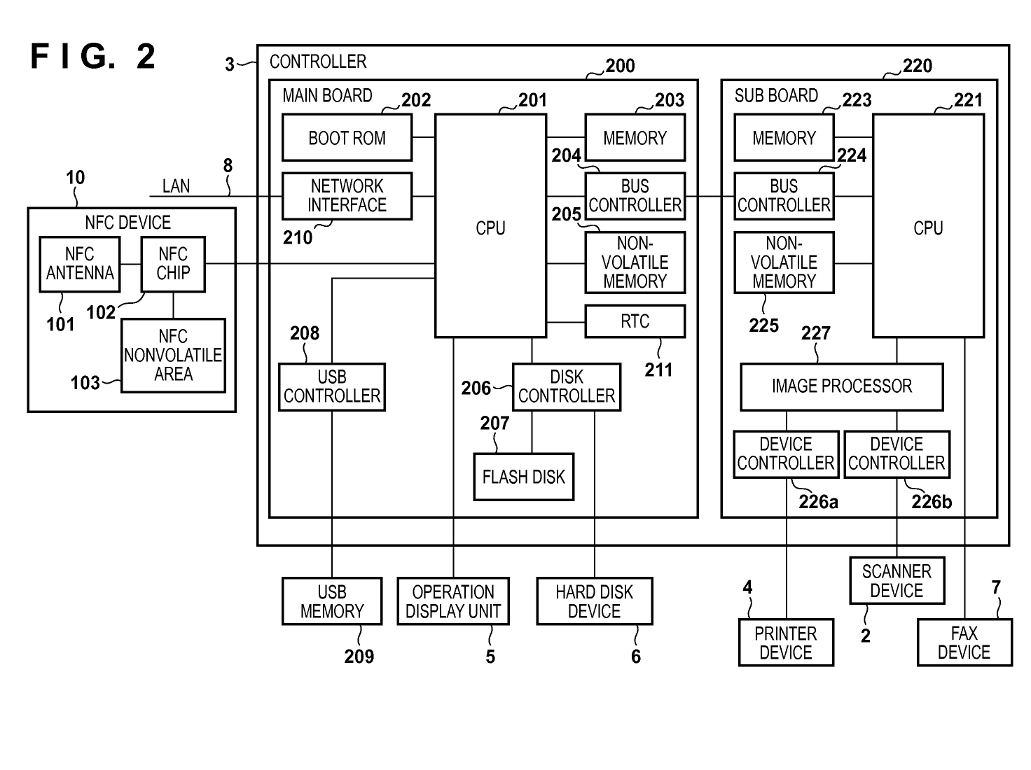

Examples of the arrangements of the controller 3 and NFC device 10 will be described with reference to a block diagram shown in FIG. 2. Note that the arrangements shown in FIG. 2 are merely examples. The arrangements of the controller 3 and NFC device 10 are not limited to those shown in FIG. 2, and various arrangements can be adopted. Note that FIG. 2 shows an arrangement in which a USB memory 209 is connectable to a main board 200, unlike FIG. 1. However, this arrangement is not essential.

The controller 3 will first be explained. The controller 3 includes the main board 200 and a sub board 220. The main board 200 is a so-called general-purpose CPU system.

A CPU 201 controls the overall operation of the main board 200 and also controls the operation of each device directly or indirectly connected to the CPU 201 by performing processing using computer programs and data loaded from a memory such as a boot ROM 202, a nonvolatile memory 205, or the hard disk device 6 into a memory 203, data input by operating the operation display unit 5 by the user, and the like.

The boot ROM 202 stores a boot program.

The memory 203 includes an area for temporarily storing the computer programs and data read out from the boot ROM 202, nonvolatile memory 205, or hard disk device 6, and a work area used by the CPU 201 to perform various processes. That is, the memory 203 can provide various areas, as needed.

A bus controller 204 controls data communication with the sub board 220. The main board 200 and sub board 220 perform data communication via the bus controller 204.

The nonvolatile memory 205 saves data not to be erased but to be saved even after the power source of the image forming apparatus 1 is turned off.

An RTC 211 has a timepiece function.

A disk controller 206 controls an operation of reading/writing data from/in a flash disk 207 (an SSD or the like) and the hard disk device 6. The CPU 201 controls the disk controller 206 to read/write data from/in the flash disk 207 and the hard disk device 6.

The flash disk 207 is a nonvolatile storage device which has a relatively small capacity and is formed from a semiconductor device.

A USB controller 208 controls an operation of reading/writing data from/in the USB memory 209. The CPU 201 controls the USB controller 208 to read/write data from/in the USB memory 209.

A network interface 210 is used to connect the main board 200 to the above-described LAN 8. The CPU 201 performs data communication with the computer 9 on the LAN 8 via the network interface 210.

The sub board 220 will be described next. The sub board 220 includes a relatively small general-purpose CPU system and image processing hardware.

A CPU 221 controls the overall operation of the sub board 220 and also controls the operation of each device directly or indirectly connected to the CPU 221 by performing processing using computer programs and data loaded from a memory such as a nonvolatile memory 225 into a memory 223, data received from an image processor 227, and the like.

The memory 223 includes an area for temporarily storing the computer programs and data read out from the nonvolatile memory 225 and the data received from the image processor 227, and a work area used by the CPU 221 to perform various processes. That is, the memory 223 can provide various areas, as needed.

A bus controller 224 controls data communication with the main board 200. The main board 200 and sub board 220 perform data communication via the bus controller 224.

The nonvolatile memory 225 saves data not to be erased but to be saved even after the power source of the image forming apparatus 1 is turned off.

The image processor 227 performs various image processes for an image received from the scanner device 2, and outputs the resultant image to an appropriate output destination. Also, the image processor 227 renders an image based on print data received from the computer 9 or data received from the hard disk device 6, performs image processing, and then sends the resultant image to the printer device 4.

A device controller 226a controls the operation of the printer device 4. A device controller 226b controls the operation of the scanner device 2.

The NFC device 10 will be explained. An NFC antenna 101 is an antenna for performing near field communication with an external device. An NFC chip 102 controls the overall operation of the NFC device 10. An NFC nonvolatile area 103 serves as a nonvolatile memory.

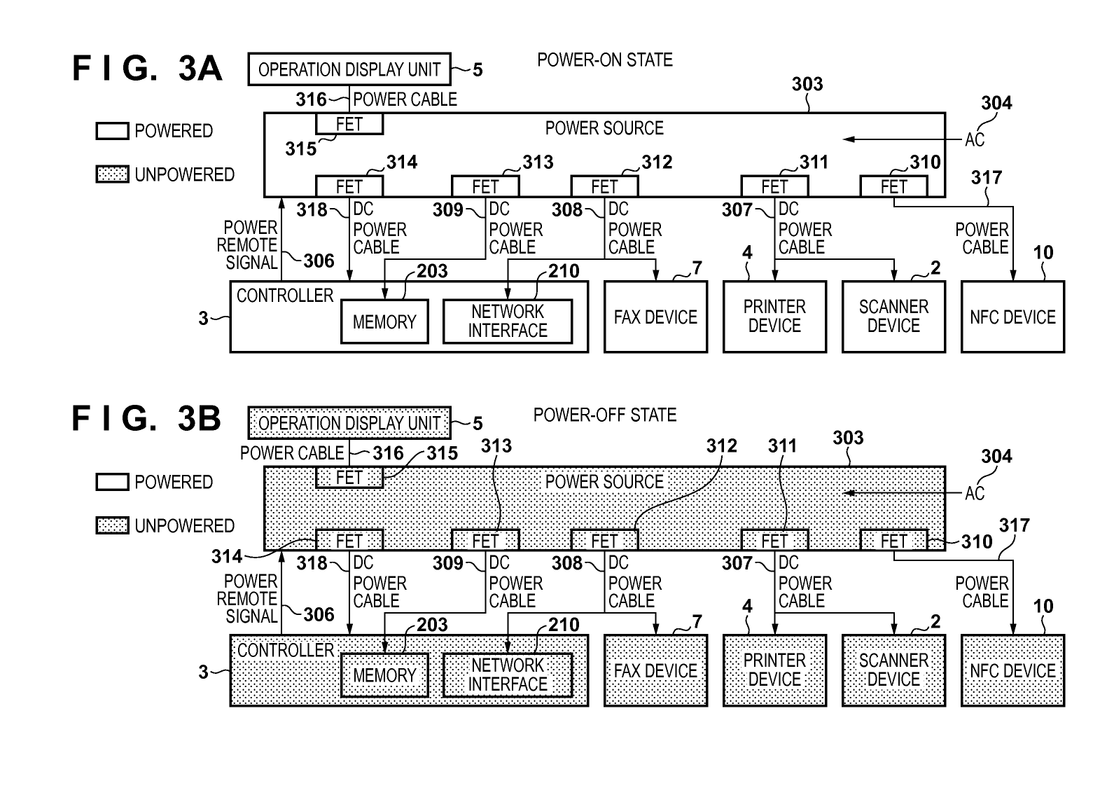

The respective functional units of the image forming apparatus 1 whose power source is ON and those of the image forming apparatus 1 whose power source is OFF will be described with reference to FIGS. 3A and 3B. Note that the power supply state includes various states in addition to the states shown in FIGS. 3A and 3B, and is not limited to those shown in FIGS. 3A and 3B.

Referring to FIGS. 3A and 3B, a power source 303 includes FETs 310 to 315. The FET 310 is connected to the NFC device 10 via a power cable 317. The FET 311 is connected to the printer device 4 and the scanner device 2 via a power cable 307. The FET 312 is connected to the FAX device 7 and the network interface 210 of the controller 3 via a power cable 308. The FET 313 is connected to the memory 203 of the controller 3 via a power cable 309. The FET 314 is connected to the respective functional units of the controller 3 except for the memory 203 and network interface 210 via a power cable 318. The FET 315 is connected to the operation display unit 5 via a power cable 316.

When the user turns on the power source by pressing a power button (not shown) provided in the image forming apparatus 1, the power source 303 supplies power to the controller 3 via the power cable 318. The controller 3 (CPU 221) which has been set in an operable state by power supply sends an ON instruction to the power source 303 via a power remote signal 306. Upon receiving the instruction, the power source 303 supplies power to the respective remaining functional units. As shown in FIG. 3A, therefore, the respective functional units of the image forming apparatus 1 and the NFC device 10 are rendered powered.

Furthermore, when the user turns off the power source by pressing the power button (not shown) provided in the image forming apparatus 1, an instruction to turn off the power source is received from the computer 9, or the controller 3 determines to turn off the power source by processing (to be described later), the controller 3 starts shutdown processing to cause the apparatus to transit to the power-off state. In this shutdown processing, the controller 3 sends an OFF instruction to the power source 303 via the power remote signal 306. Therefore, upon receiving the instruction, the power source 303 cuts off power supply to the respective functional units. Consequently, as shown in FIG. 3B, the respective functional units of the image forming apparatus 1 and the NFC device 10 are rendered unpowered.

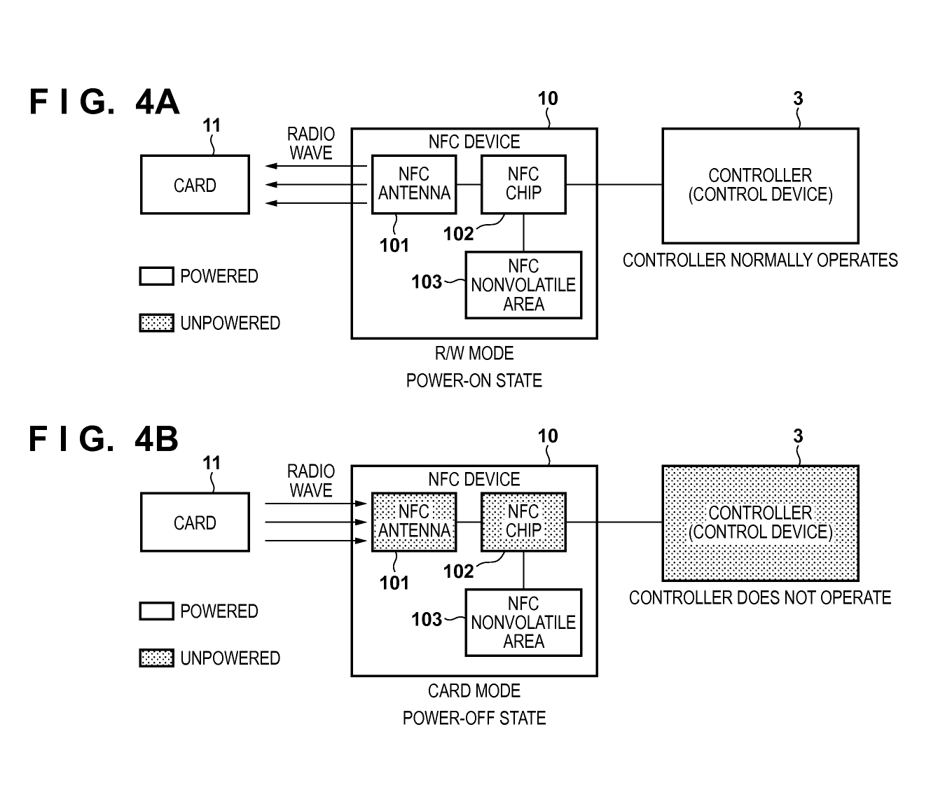

Although the unpowered functional units do not operate, the operation rules of the NFC device 10 are different from those of the functional units. The operation rules of the NFC device 10 will be described with reference to FIGS. 4A and 4B. In this example, the card 11 is used as an external device. However, the same applies to the mobile terminal 12.

While the power source of the image forming apparatus 1 is in the ON state, power is supplied to each of the controller 3 and NFC device 10. Therefore, as shown in FIG. 4A, each of the controller 3 and the NFC device 10 is powered. The NFC antenna 101 generates a radio wave, thereby generating an induced current in the card 11. This current is used as an electromotive force to operate the chip of the card 11. This enables the NFC chip 102 to read out information recorded in the chip, and write information in the chip. The information read out from the card 11 can be stored in the NFC nonvolatile area 103 or sent to the controller 3. The card 11 can be used to, for example, log in to the image forming apparatus 1.

On the other hand, when the power source of the image forming apparatus 1 is in the OFF state, power supply to each of the controller 3 and the NFC device 10 is cut off. Therefore, as shown in FIG. 4B, each of the controller 3 and the NFC device 10 is unpowered. Even if the NFC device 10 is unpowered, however, an induced current flows through the NFC antenna 101 by a radio wave from the card 11 by bringing the card 11 close to the NFC antenna 101, and the NFC chip 102 operates using the induced current as an electromotive force. That is, even if the power source of the image forming apparatus 1 is in the OFF state, it is possible to operate the NFC device 10 (NFC chip 102) by bringing the card 11 close to the NFC antenna 101. Consequently, this enables the NFC chip 102 to read out information recorded in the card 11 and write information in the card 11. The information read out from the card 11 can be stored in the NFC nonvolatile area 103.

When the mobile terminal 12 is used in place of the card 11, even if the power source of the image forming apparatus 1 is in the OFF state, it is possible to activate the NFC device 10 by bringing the mobile terminal 12 close to the NFC device 10, and transmit condition information generated on the side of the mobile terminal 12 to the NFC device 10. The NFC chip 102 writes, in the NFC nonvolatile area 103, the condition information received via the NFC antenna 101. This makes it possible to newly register condition information in the NFC nonvolatile area 103 or rewrite already registered condition information even if the power source of the image forming apparatus 1 is in the OFF state.

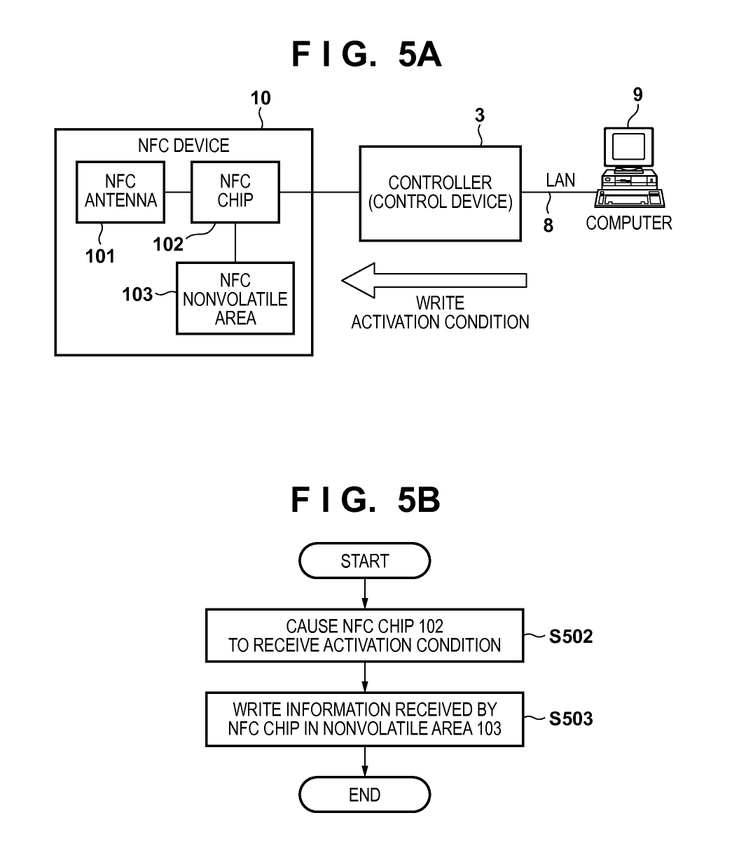

Processing performed by the controller 3 and NFC chip 102 for registration (including new registration and overwriting registration) of condition information transmitted by the computer 9 via the LAN 8 in the NFC nonvolatile area 103 in the ON state of the power source of the image forming apparatus 1 will be described with reference to FIGS. 5A and 5B.

<Step S502>

When the computer 9 transmits condition information via the LAN 8, the controller 3 acquires the condition information via the LAN 8, and sends the acquired condition information to the NFC device 10.

<Step S503>

The NFC chip 102 registers the condition information sent by the controller 3 in the NFC nonvolatile area 103.

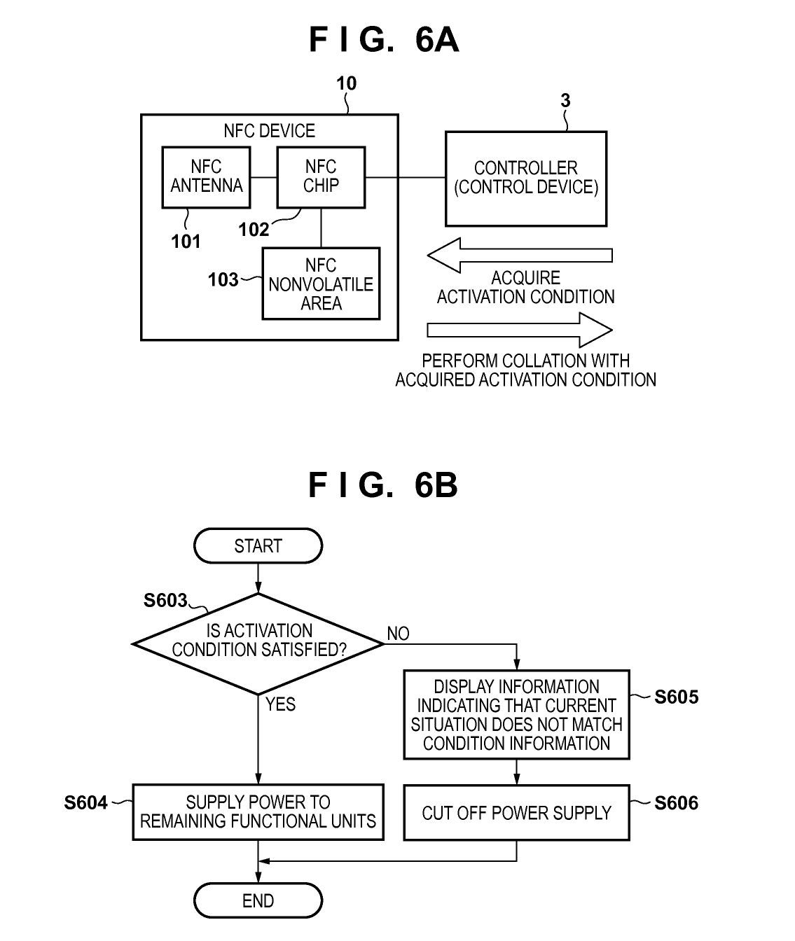

Next, processing performed by the controller 3 and NFC chip 102 when the user turns on the power source by pressing the power button (not shown) provided in the image forming apparatus 1 in the OFF state of the power source of the image forming apparatus 1 will be described with reference to FIGS. 6A and 6B. Note that when the processing according to the view and flowchart respectively shown in FIGS. 6A and 6B is performed, the condition information has already been registered in the NFC nonvolatile area 103 by the processing according to the view and flowchart respectively shown in FIGS. 5A and 5B or the like.

<Step S603>

When the user turns on the power source by pressing the power button (not shown) provided in the image forming apparatus 1, the power source 303 supplies power to the controller 3 via the power cable 318, as described above. The controller 3 (CPU 221) which has been set in the operable state by power supply instructs, via a power remote signal 306, the power source 303 to supply power to the NFC device 10. Therefore, upon receiving the instruction, the power source 303 also supplies power to the NFC device 10.

The controller 3 reads out the condition information registered in the NFC nonvolatile area 103 into the memory 203, and determines whether the current situation matches a condition indicated by the readout condition information.

Assume, for example, that the condition indicated by the condition information is “a time period except for the time period from 10 p.m. to 8 a.m.”. In this case, the controller 3 acquires the current time measured by the RTC 211, and determines whether the acquired current time falls within the time period from 10 p.m. to 8 a.m. If the current time falls within the time period from 10 p.m. to 8 a.m., it is determined that the condition indicated by the condition information is not satisfied; otherwise, it is determined that the condition indicated by the condition information is satisfied.

If it is determined that the condition indicated by the condition information is satisfied, the process advances to step S604; otherwise, the process advances to step S605.

<Step S604>

The controller 3 instructs, via a power remote signal 306, the power source 303 to supply power to the respective remaining functional units. Therefore, upon receiving the instruction, the power source 303 also supplies power to the respective remaining functional units.

<Step S605>

The controller 3 instructs, via a power remote signal 306, the power source 303 to supply power to the operation display unit 5. Therefore, upon receiving the instruction, the power source 303 supplies power to the operation display unit 5. The controller 3 then causes the operation display unit 5 to display information indicating that the current situation does not match the condition indicated by the condition information. The displayed contents are not limited to specific contents. For example, the condition indicated by the condition information and the current situation may be displayed together. A sentence “<a sentence indicating the current situation> does not match <a sentence indicating the condition indicated by the condition information>” may be displayed. Note that the processing in this step is not essential. If, for example, it is desirable to omit the processing of supplying power to the operation display unit 5, the processing in this step may be omitted.

<Step S606>

The controller 3 performs the above-described shutdown processing. This sends an OFF instruction to the power source 303 via the power remote signal 306. Upon receiving the instruction, the power source 303 cuts off power supply to the respective functional units being supplied with power.

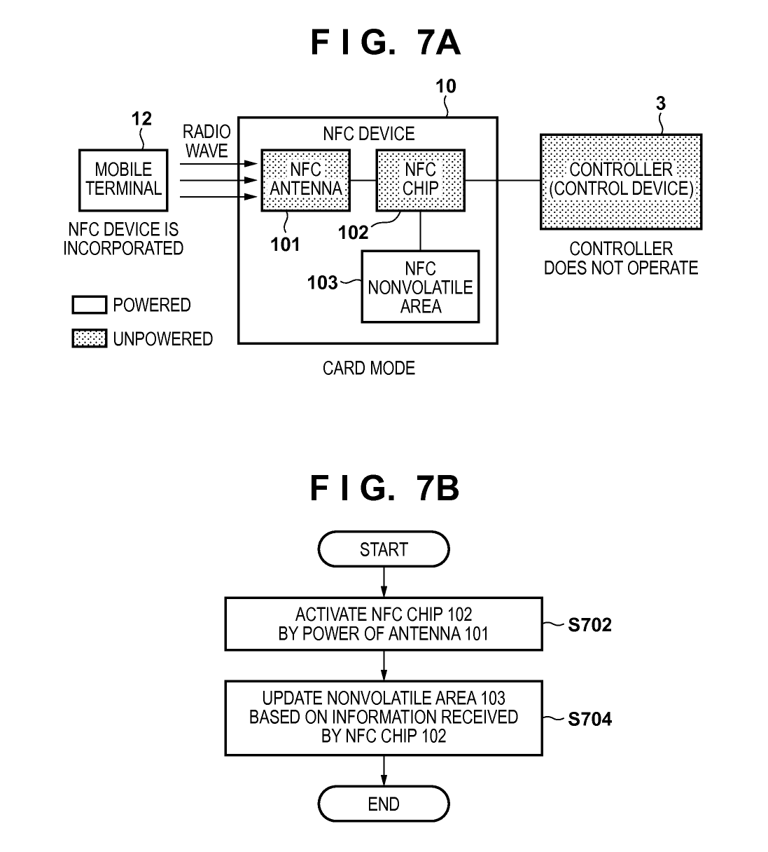

Processing performed by the NFC chip 102 to rewrite the condition information registered in the NFC nonvolatile area 103 by condition information registered in the mobile terminal 12 by bringing the mobile terminal 12 close to the NFC antenna 101 in the OFF state of the power source of the image forming apparatus 1 will be described with reference to FIGS. 7A and 7B.

<Step S702>

Similarly to the card 11, the mobile terminal 12 generates a radio wave. Therefore, by bringing the mobile terminal 12 close to the NFC antenna 101, an induced current flows through the NFC antenna 101 by the radio wave from the mobile terminal 12, and the NFC chip 102 operates using the induced current as an electromotive force.

<Step S704>

The mobile terminal 12 transmits the condition information to the NFC device 10. Thus, the NFC chip 102 registers the condition information received via the NFC antenna 101 in the NFC nonvolatile area 103. This registration processing may be overwriting registration processing for the already registered condition information or new registration processing. As described above, even if the power source of the image forming apparatus 1 is in the OFF state, the condition information can be updated.

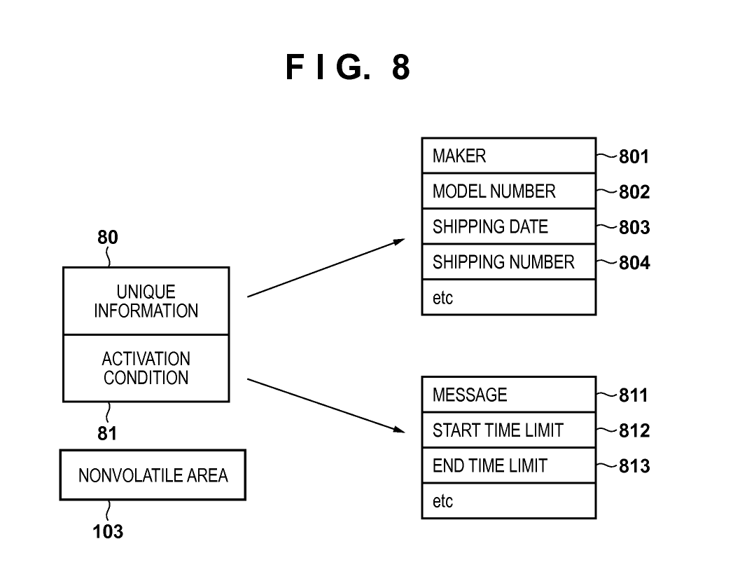

An example of the format of the condition information will be described with reference to FIG. 8. The condition information includes unique information 80 which is unique to the image forming apparatus 1 and cannot be rewritten, and an activation condition 81 which is rewritable information.

The unique information 80 includes information 801 indicating the maker of the image forming apparatus 1, information 802 indicating the model number of the image forming apparatus 1, information 803 indicating the shipping date of the image forming apparatus 1, and information 804 indicating the shipping number of the image forming apparatus 1.

The activation condition 81 includes a message 811 to be displayed in step S605, information 812 indicating the start time (start time limit) at which an operation of maintaining the power source of the image forming apparatus 1 in the OFF state starts, and information 813 indicating the end time (end time limit) at which the operation of maintaining the power source of the image forming apparatus 1 in the OFF state ends.

The format of the condition information is not limited to the structure shown in FIG. 8, as a matter of course. For example, the activation condition 81 may be omitted from the condition information and only the unique information 80 may be included. In this case, if the maker, model number, shipping date, and shipping number of the image forming apparatus 1 respectively match the pieces of information 801 to 804, it is determined that the current situation matches the condition indicated by the condition information (the power source of the image forming apparatus 1 may be maintained in the ON state).

Alternatively, the unique information 80 may be omitted from the condition information and only the activation condition 81 may be included. In this case, if the current time falls outside a time period from the start time indicated by the information 812 to the end time indicated by the information 813, it is determined that the current situation matches the condition indicated by the condition information (the power source of the image forming apparatus 1 may be maintained in the ON state).

As described above, according to this embodiment, when the image forming apparatus does not satisfy the activation condition, even if the user turns on the power source, the apparatus immediately starts the shutdown processing. Consequently, it is possible to prevent the power source from being maintained in the ON state during a specific time period or under a specific condition. This can suppress wasteful power consumption. Furthermore, even if the power source of the image forming apparatus is in the OFF state, it is possible to rewrite the condition information, thereby improving the convenience of the system administrator/serviceman.

### Second Embodiment

The first embodiment assumes that only one piece of condition information is registered in the NFC nonvolatile area 103. However, a plurality of pieces of condition information may be registered in an NFC nonvolatile area 103. In this case, in the ON state of the power source of an image forming apparatus 1 before the start of processing according to a view and flowchart respectively shown in FIGS. 6A and 6B, a list of pieces of information respectively indicating the pieces of condition information registered in the NFC nonvolatile area 103 is displayed on an operation display unit 5. Among the plurality of pieces of condition information, condition information selected by the user by using the operation display unit 5 is set as condition information to be used for the subsequent processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-086799, filed Apr. 18, 2014, which is hereby incorporated by reference herein in its entirety.

What is claimed is:

1. An image forming apparatus comprising:
a storage unit configured to store condition information indicating a condition for allowing a power source of said image forming apparatus to be set in an ON state; and
an activation unit configured to, in response to input of an instruction to turn on the power source of said image forming apparatus, activate a control unit configured to refer to the condition information stored in said storage unit,
wherein the control unit activated by said activation unit refers to the condition information stored in said storage unit, and if it is determined that the condition indicated by the condition information is not satisfied, performs shutdown processing of said image forming apparatus.

2. The apparatus according to claim 1, wherein said storage unit comprises a memory included in a communication unit configured to perform near field communication with an external device.

3. The apparatus according to claim 2, wherein the external device stores the condition information for allowing the power source of said image forming apparatus to be set in the ON state in the memory by performing near field communication with the communication unit while the power source of the image forming apparatus is in an OFF state.

4. The apparatus according to claim 1, wherein the control unit activated by said activation unit refers to the condition information upon input of the instruction to turn on the power source of the image forming apparatus, and if it is determined that the condition indicated by the condition information is not satisfied, causes a display unit of said image forming apparatus to display information indicating that the condition indicated by the condition information is not satisfied.

5. The apparatus according to claim 1, further comprising a selection unit configured to select condition information to be referred to by the control unit from pieces of condition information stored in said storage unit.

6. A control method for an image forming apparatus including a storage unit configured to store condition information indicating a condition for allowing a power source of the image forming apparatus to be set in an ON state, the method comprising:
an activation step of, in response to input of an instruction to turn on the power source of the image forming apparatus, activating a control unit configured to refer to the condition information stored in the storage unit,
wherein the control unit activated in the activation step refers to the condition information stored in the storage unit, and if it is determined that the condition indicated by the condition information is not satisfied, performs shutdown processing of the image forming apparatus.

7. A non-transitory computer-readable storage medium storing a computer program for causing a computer to function as the activation unit and the control unit of an image forming apparatus defined in claim 1.
